(19) United States
(12) Patent Application Publication
(10) Pub. No.: US 2026/0184114 A1
(43) Pub. Date: Jul. 2, 2026

(54) FRONT MOTORCYCLE TYRE

(71) Applicant: Pirelli Tyre S.p.A., Milano (IT)

(72) Inventors: Giuliano BONACCORSI, Milano (IT); Matteo TORCHIANA, Milano (IT); Rocco PARENTE, Milano (IT)

(73) Assignee: Pirelli Tyre S.p.A., Milano (IT)

(21) Appl. No.: 19/130,845

(22) PCT Filed: Nov. 20, 2023
(86) PCT No.: PCT/IB2023/061673

§ 371 Date: May 16, 2025

(30) Foreign Application Priority Data
Nov. 21, 2022 (IT) 102022000023889

(51) Int. Cl. B60C 11/00

(52) U.S. Cl. CPC B60C 11/0058; B60C 2011/0025; B60C 2200/10

(57) ABSTRACT

A front tyre (1) for motorcycle wheels is described comprising an equatorial plane (X-X), and a tread band (8) having an overall axial extension (L) and comprising a radially inner portion (12) made with a first vulcanized elastomeric material and a radially outer portion (11) comprising: a1) a central annular portion (L1) arranged astride the equatorial plane (X-X) of the tyre (1) and made with the first vulcanized elastomeric material, and a2) a pair of lateral annular portions (L2, L3) arranged at opposite sides of the central annular portion (L1) with respect to the equatorial plane (X-X) of the tyre (1) and made with a second vulcanized elastomeric material. In the tyre (1), a ratio RI between the dynamic elastic modulus E′ of the second vulcanized elastomeric material, measured at a frequency of 10 Hz and at 23° C., and the dynamic elastic modulus E′ of the first vulcanized elastomeric material, measured at a frequency of 10 Hz and at 23° C., is comprised between 0.6 and 1.2. In the tyre (1), a ratio R2 between the tandelta of the second vulcanized elastomeric material, measured at a frequency of 10 Hz and at 70° C., and the tandelta of the first vulcanized elastomeric material, measured at a frequency of 10 Hz and at 23° C., is comprised between 0.6 and 1.2.

### FIELD OF THE INVENTION

The present invention relates to a front motorcycle tyre.

In particular, the present invention relates to a motorcycle tyre in the “Supersport” and/or “Hypersport” segment, with large displacement (for example 600 or 1000 cm³ or more), and/or high power (for example 200 horsepower or more), also used on a racetrack.

### RELATED ART

Motorcycle tyres are known for example from EP 2 662 226 A1 and from WO 2019/082012.

### SUMMARY OF THE INVENTION

In recent times, a tendency has been observed to introduce into the market high-powered Supersport or Hypersport motorcycles. Indeed, on the market there are, for example, motorcycles for road use having a displacement of 1000 cm³ and higher, with powers of 200 horsepower or even higher.

The Applicant has noted an increasing demand for high performance tyres both for demanding sports driving (which may achieved, for example, on track) and for road use of the motorcycle throughout the year, in particular in adverse weather conditions.

In this regard, the Applicant has in particular observed a recent tendency of users of finding combined together in the tyres fitted on Supersport motorcycles drivability and performance in extreme maneuvering and speed conditions on dry and/or hot surfaces (hereinafter also indicated as “hot” use conditions) together with drivability and road holding in wet or humid conditions and/or in cold weather or in non-optimal road surface conditions (hereinafter also indicated as “cold” use conditions) and, this, while keeping the performance of the tyre as constant as possible over time.

Meeting such mutually contrasting requirements with a single pair of tyres is a particularly challenging task where, typically, a different kind of action is taken for each of the above requirements, applying solutions suited for the specific problem, but in contrast with the others.

In order to improve the drivability performance and the performance on dry and/or hot ground, as well as in wet or humid conditions and/or in cold weather or in non-optimal road surface, it is necessary in particular to ensure optimal adherence to the ground in these different driving conditions.

In order to improve the grip of the tyre, it is possible to use in order to make the tread band so-called soft vulcanized elastomeric materials, that best adapt to the roughness of the road surface, copying the irregular profile thereof. These vulcanized elastomeric materials are typically characterized by a low elastic modulus and/or high hysteresis.

The Applicant has however observed that vulcanized elastomeric materials that are too soft result in a decrease in stability when travelling along a straight course and a decrease in mileage of the tyre.

In order to overcome the aforementioned problem, tyres made with different vulcanized elastomeric materials have been proposed. Typically, a softer vulcanized elastomeric material at the shoulder and a less soft vulcanized elastomeric material at the crown.

Tyres thus configured are for example described in EP 2 662 226.

In relation to this configuration of the tread band, the Applicant has however observed that the drivability performance and the performance of the tyre in the “cold” use conditions tend to degrade, in particular in the case of road use on wet ground, significantly impairing the performance of the tyre.

In order to try to meet the aforementioned contrasting requirements with a single pair of tyres, tyres have also been proposed with tread bands made with different vulcanized elastomeric materials, typically, a vulcanized elastomeric material with a higher content of a carbon black filler at the shoulder and several vulcanized elastomeric materials with higher content of white fillers at the crown and at intermediate annular portions of the tread band.

The whole thing, in combination with a suitable distribution and arrangement of the grooves of the tread band at the interface between vulcanized elastomeric materials of different composition, as described, for example, in WO 2019/082012 in the name of the Applicant.

In its search for a constant improvement of motorcycle tyres, in particular front tyres, the Applicant has set itself the dual task of maintaining the drivability performance and the performance of a front tyre in the “hot” use conditions at an excellent level whilst improving at the same time the drivability and grip performance in the aforementioned “cold” use conditions of the front tyre both on dry and on wet ground.

The Applicant has found that it is possible to achieve such a dual task by adopting a so-called “cap-and-base” tread band configuration of the front tyre and by using vulcanized elastomeric materials having suitable dynamic mechanical properties in the “cold” and “hot” use conditions of the tyre.

In particular, the Applicant has found that, to this end, it is necessary to simultaneously adopt the following provisions:
i) a configuration of the radially outer portion of the tread band of the type comprising a central annular portion arranged astride of the equatorial plane of the tyre and a pair of lateral annular portions arranged at axially opposite sides of the central annular portion,
ii) using a stiffer first vulcanized elastomeric material in the radially inner portion of the tread band and in the central annular portion of the radially outer portion of the tread band and a softer second vulcanized elastomeric material in the lateral annular portions of the radially outer portion of the tread band, and
iii) using as first and second vulcanized elastomeric material materials having specific mechanical stiffness characteristics, correlated to the dynamic elastic modulus E′, in the “cold” use conditions and specific mechanical characteristics of hysteresis, correlated to the tandelta, in the “hot” use conditions of the tyre.

In this regard, the Applicant has in fact found that in order to achieve the aforementioned dual task it is necessary to evaluate the dynamic mechanical characteristics of the vulcanized elastomeric materials used to make the different portions of the tread band in a differentiated manner for each elastomeric material and in the specific stress and temperature conditions which are correlated to the actual use conditions of each material that is subjected, during use of the front tyre, to different types of stress and temperatures depending on the position thereof in the tread band.

As far as the “cold” use of the tyre is concerned, the Applicant has in particular found that dynamic mechanical characteristics predictive of the behavior of the front tyre in such use conditions are the dynamic elastic modulus E′ measured at a frequency of 10 Hz and at 23° C. for all the elastomeric materials that make up the tread band.

Conversely and as far as the “hot” use of the front tyre is concerned, the Applicant has found that dynamic mechanical characteristics predictive of the behavior of the tyre in such use conditions are the tandelta respectively measured:
at a frequency of 10 Hz and at 23° C. for the first vulcanized elastomeric material of the radially inner portion and of the central annular portion of the radially outer portion of the tread band; and
at a frequency of 10 Hz and at 70° C. for the second vulcanized elastomeric material of the lateral annular portions of the radially outer portion of the tread band.

The Applicant has thus surprisingly found that the desired maintaining of the drivability and grip performance in the aforementioned “hot” use conditions and improvement of the drivability and grip performance in the aforementioned “cold” use conditions of the front tyre can be simultaneously achieved by keeping the following dynamic mechanical characteristics at values close to one:
the ratio between the “cold” dynamic elastic modulus E′ of the second and of the first vulcanized elastomeric material; and
the ratio between the “hot” tandelta of the second and of the first vulcanized elastomeric material.
i.e. by keeping the “cold” dynamic elastic modulus E′ and the “hot” tandelta of such vulcanized elastomeric materials at values similar to one another.

The invention therefore relates to a front motorcycle tyre comprising an equatorial plane and a tread band having an overall axial extension,
wherein the tread band comprises:
a) a radially outer portion comprising:
   a1) a central annular portion arranged astride the equatorial plane of the tyre and made with a first vulcanized elastomeric material, and
   a2) a pair of lateral annular portions arranged at opposite sides of said central annular portion with respect to the equatorial plane of the tyre, said lateral annular portions being made with a second vulcanized elastomeric material;
b) a radially inner portion extending below the radially outer portion of the tread band and along the entire axial extension thereof, said radially inner portion being made with said first vulcanized elastomeric material;
wherein a ratio R1 between the dynamic elastic modulus E′ of the second vulcanized elastomeric material of the lateral annular portions of the radially outer portion of the tread band, measured at a frequency of 10 Hz and at 23° C., and the dynamic elastic modulus E′ of the first vulcanized elastomeric material of the central annular portion of the radially outer portion and of the radially inner portion of the tread band, measured at a frequency of 10 Hz and at 23° C., is comprised between 0.6 and 1.2; and
wherein a ratio R2 between the tandelta of the second vulcanized elastomeric material of the lateral annular portions of the radially outer portion of the tread band, measured at a frequency of 10 Hz and at 70° C., and the tandelta of the first vulcanized elastomeric material of the central annular portion of the radially outer portion and of the radially inner portion of the tread band, measured at a frequency of 10 Hz and at 23° C., is comprised between 0.6 and 1.2.

Basically, it appears that in the front tyre according to the invention there is an effective convergence:
i) of the characteristics of ground “copying” of the front tyre, correlated to the hysteresis characteristics in the “hot” use conditions, and
ii) of the characteristics of response homogeneity to the stresses that a front tyre receives in the “cold” use conditions.

The Applicant has found that this convergence of characteristics allows to maintain the drivability and grip performance in dry and/or hot ground conditions over time and, at the same time, to improve the drivability and grip performance in wet or humid conditions and/or in cold weather or in non-optimal road surface conditions in the “cold” use conditions of the front motorcycle tyre, in particular a front motorcycle tyre of the “Supersport” and/or “Hypersport” segment.

Without wishing to be bound by any interpretative theory, the Applicant deems that in the “hot” use conditions the front tyre as defined above has a substantially uniform hysteretic behavior of the tread band in the shoulder areas, i.e. in the areas most stressed in such use conditions.

This result appears to be surprising since the use in the radially inner portion of the tread band of a relatively “stiff” vulcanized elastomeric material seemed not only poorly suitable for providing adequate performance in such use conditions, but even prone to cause—on the contrary—a drastic worsening of the front tyre performance.

The Applicant has instead found that a substantially uniform dynamic and hysteretic behavior of the tread band in the “hot” use conditions of the front tyre allows to preserve the “copying” characteristics of the tyre, avoiding phenomena of performance degradation and premature wearing.

Conversely and again without wishing to be bound by any interpretative theory, the Applicant deems that in the “cold” use conditions the front tyre as defined above has a substantially uniform dynamic behavior of the tread band as a whole in such use conditions.

The Applicant has in particular observed, in the “cold” use conditions of the front tyre, a very homogeneous behavior of the vulcanized elastomeric materials that constitute the tread band, homogeneous behavior that is deemed to be essentially correlated to the homogeneity of the “cold” dynamic elastic modulus E′ values of the second and of the first vulcanized elastomeric material.

Advantageously, the front tyre according to the invention therefore allows not only to maintain optimal drivability and grip performance on dry and/or hot ground use conditions, typical of use on a racetrack, but is also capable to achieve improved drivability and grip performance in the “cold” use conditions, typical of road use.

From the practical point of view, this translates into an advantage that is particularly appreciated by the users, i.e. that of not necessarily having to replace the front tyre when moving from racetrack use to road use and vice-versa.

In the present description and in the following claims, all numerical entities indicating amounts, parameters, percentages and so forth are to be understood as being preceded in all instances by the term “about” unless indicated otherwise. Moreover, all of the ranges of numerical entities include all the possible combinations of the maximum and minimum numerical values and all the possible intermediate ranges, in addition to those specifically indicated hereinbelow.

Unless otherwise indicated, all of the ranges of numerical entities also include the maximum and minimum numerical values.

For the purposes of the present invention, the following definitions apply.

The term “phr” (acronym for parts per hundred parts of rubber) indicates the parts by weight of a given component of elastomeric compound per 100 parts by weight of the elastomeric polymer considered net of possible extender plasticizer oils.

The term “elastomeric material”, rubber”, “elastomeric polymer” or “elastomer” is used to indicate a material comprising a vulcanizable natural or synthetic polymer and a reinforcing filler, wherein such a material, at room temperature and after having been subjected to vulcanization, can undergo deformations caused by a force and is capable of quickly and energetically recovering the substantially original shape and size after the elimination of the deforming force (according to the definitions of standard ASTM D1566-11 Standard Terminology Relating To Rubber).

The term “diene polymer” is used to indicate a polymer or copolymer deriving from the polymerization of one or more different monomers, at least one of which is a conjugated diene (conjugated diolefin).

The term “compound” or “elastomeric compound” is used to indicate the mixture obtainable by mixing and possible heating of at least one elastomeric polymer with at least one of the additives commonly used in the preparation of tyre compounds.

The term “vulcanizable compound” or “vulcanizable elastomeric compound” is used to indicate the elastomeric mixture ready for vulcanization that can be obtained by incorporating into an elastomeric compound all additives including vulcanization additives.

The term “vulcanized elastomeric material” is used to indicate the material obtainable by vulcanizing a vulcanizable elastomeric compound.

The term “vulcanization” is used to indicate the cross-linking reaction in a natural or synthetic rubber induced by a cross-linking agent, typically sulfur-based.

The term “vulcanizing agent” is used to indicate a compound capable of transforming natural or synthetic rubber into an elastic and strong material thanks to the formation of a three-dimensional network of inter- and intra-molecular bonds. Typical vulcanizing agents are sulfur-based compounds such as elemental sulfur, polymeric sulfur, sulfur donor agents such as bis [(trialkoxysilyl) propyl]polysulfides, thiurams, dithiodimorpholines, and caprolactam-disulfide.

The term “vulcanization accelerant” is used to indicate a compound capable of decreasing the duration of the vulcanization process and/or the operating temperature, such as for example TBBS, sulfenamides in general, thiazoles, dithiophosphates, dithiocarbamates, guanidines, as well as sulfur donors such as thiurams.

The term “vulcanization activator” is used to indicate a compound capable of further facilitating vulcanization by causing it to occur in a shorter time and possibly at lower temperatures. An example of an activator is the stearic acid-zinc oxide system.

The term “vulcanization retardant” is used to indicate a compound that is capable of delaying the start of the vulcanization reaction and/or suppressing unwanted secondary reactions, for example N-(cyclohexylthio)phthalimide (CTP).

The term “reinforcing filler” is used to indicate a reinforcing material typically used in the field to improve the mechanical properties of tyres, preferably selected from carbon black and “white filler”.

The term “white filler” is used to indicate a conventional reinforcing material used in the field selected from conventional silica and silicates, such as silica sand precipitated with strong acids, preferably amorphous, diatomaceous earth, calcium carbonate, titanium dioxide, talc, alumina, aluminosilicates, kaolin, silicate fibers, phyllosilicates such as sepiolite, palygorskite also known as attapulgite, montmorillonite, halloysite and similar, possibly modified by acid treatment and/or derivatized, and mixtures thereof. Typically, white fillers have surface hydroxyl groups.

The term “front motorcycle tyre” is used to indicate a tyre having a high curvature ratio (typically equal to or greater than 0.35) and capable of reaching high camber angles while running along a bend.

The term “curvature ratio” is used to indicate the ratio between the distance comprised between the radially highest point of the tread band and the maximum width of radial section of the tyre (such a distance also being identified as “arrow”), and the same maximum width of the tyre, in a cross section thereof.

The term “axial extension” of the tread band or portions thereof is used to indicate the development of the radially outermost profile of the tread band or portions thereof in a cross-section of the tyre carried out by means of a plane containing the axis of rotation of the tyre.

The term “axial half-extension” of the tread pattern, of the tread band or of portions thereof is used to indicate the development, from the equatorial plane and towards an axially outermost end of the tyre, of the radially outermost profile of the tread band or of portions thereof in a cross section of the tyre carried out by means of a plane containing the rotation axis of the tyre.

The term “equatorial plane” of the tyre is used to indicate a plane perpendicular to the rotation axis of the tyre and that divides the tyre into two symmetrically equal parts.

The term “width” is used to indicate a dimension measured along a direction perpendicular to the equatorial plane.

The term “tread pattern” is used to indicate the representation of all of the points of the tread band (sipes included) on a plane perpendicular to the equatorial plane of the tyre and tangent to the maximum diameter of the tyre. The tread pattern is defined by a plurality of solid portions separated by sipes and possibly including grooves.

The terms “radial” and “axial” and the expressions “radially inner/outer” and “axially inner/outer” are used with reference, respectively, to a direction substantially parallel to the equatorial plane of the tyre and to a direction substantially perpendicular to the equatorial plane of the tyre, i.e. to a direction substantially perpendicular to the rotation axis of the tyre and to a direction substantially parallel to the rotation axis of the tyre, respectively.

The terms “circumferential” and “circumferentially” are used with reference to the direction of circumferential extension of the tyre, i.e. to the rolling direction of the tyre, which corresponds to a direction lying on a plane coinciding with or substantially parallel to the equatorial plane of the tyre.

The term “circumferential extension” of the tyre, or of the tread band or of portions thereof, is used to indicate the plan development of the radially outermost surface of the tyre, or of the tread band or of portions thereof, on a plane tangent to the tyre.

The expressions “axially inner” and “axially outer” indicate a position respectively closer to, and farther away from, the equatorial plane with respect to a reference element.

The term “radial carcass structure” is used to indicate a carcass structure comprising a plurality of reinforcing cords each of which is oriented, in a crown portion of the tyre, along a substantially axial direction. Such reinforcing cords can be incorporated in a single carcass ply or in several carcass plies (preferably two) radially juxtaposed over one another.

The term “substantially axial direction” is used to indicate a direction inclined, with respect to the equatorial plane of the tyre, by an angle comprised between 60° and 90°.

The term “substantially circumferential direction” is used to indicate a direction oriented, with respect to the equatorial plane of the tyre, at an angle comprised between 0° and 20°.

The term “static mechanical properties” of a tread compound is used to indicate the tensile stress-strain properties of vulcanized and thermoplastic rubbers according to the UNI 6065:2001 standard measured at a predetermined temperature on samples of the compound vulcanized at 170° C. for 10 minutes.

The term “dynamic mechanical properties” of a tread compound is used to indicate mechanical properties measured using an Instron Model 1341 dynamic device in the tension-compression mode as described herein.

A test piece of cross-linked material (170° C. for 15 minutes) was used, having a cylindrical shape (length=25 mm; diameter=18 mm), preloaded under compression up to a longitudinal deformation of 25% with respect to the initial length and kept at a predetermined temperature (for example 23° C. and 70° C.) for the entire duration of the test. After a waiting time of 2 minutes followed by a mechanical pre-conditioning of 125 cycles at 10 Hz at 7.5% deformation amplitude with respect to the length under preload, the test piece was subjected to a dynamic sinusoidal stress having an amplitude of ±3.5% with respect to the length under preload, with a predetermined frequency, for example of 10 Hz. The dynamic mechanical properties are expressed in terms of values of dynamic elastic modulus E′ and tandelta (loss factor). The value tandelta was calculated as the ratio between the viscous dynamic modulus (E″) and the elastic dynamic modulus E′.

The term “overall void to rubber ratio” is used to indicate the ratio between the overall surface of the grooves of a certain annular portion of tread band (possibly of the whole tread band) and the overall surface of the entire tread band.

The term “annular portion” or “annular sector” is used to indicate a portion or a sector of tread band circumferentially extending for the entire tread band and having a predetermined axial extension.

The distance of an annular tread portion or of an annular tread sector from the equatorial plane or the distance between annular portions or annular sectors is evaluated axially by referring to the central plane parallel to the equatorial plane of the portion(s), unless indicated otherwise.

The term “void to rubber ratio of an annular portion” or “void to rubber ratio of an annular sector”, or generically “void to rubber ratio”, is used to indicate the ratio between the overall surface of the grooves of an annular portion or of an annular sector and the overall surface of the annular portion itself or of the annular sector itself.

The term “substantially free of grooves” with reference to a portion of the tread band of the tyre is used to indicate that in the portion of tread band considered the “void to rubber ratio” as defined above is very close or substantially equal to zero, for example it has a value of less than 0.2%.

The term “pitch” of the tyre is used to indicate the group of grooves and solid parts arranged so as to form a portion of the pattern which is repeated on the tread band, substantially the same and without interruption along the circumferential development of the tread band. Along the circumferential development of the tread band, the pitches can have different circumferential lengths and can be circumferentially offset from one another on opposite sides of the equatorial plane of the tyre.

The expression “module” referring to a tread band, and in particular to the tread pattern, is used to indicate a portion of tread pattern which is repeated the same in succession along the entire circumferential extension of the tread band itself. The modules, whilst keeping the same pattern configuration, can nevertheless have a different circumferential length and/or have respective portions positioned on opposite sides of the equatorial plane of the tyre and circumferentially offset along the circumferential development of the tyre itself.

In this second case, the tyre comprises “pitches” that are circumferentially offset from one another on opposite sides of the equatorial plane.

The present invention can, in one or more of the aforementioned aspects, have one or more of the preferred features given hereinafter, which can be combined with one another as desired according to the application requirements.

Preferably, the ratio R1 between the dynamic elastic modulus E′ of the second vulcanized elastomeric material of the lateral annular portions of the radially outer portion of the tread band, measured at a frequency of 10 Hz and at 23° C., and the dynamic elastic modulus E′ of the first vulcanized elastomeric material of the central annular portion of the radially outer portion and of the radially inner portion of the tread band, measured at a frequency of 10 Hz and at 23° C., is comprised between 0.7 and 1.1.

In this way, it is advantageously possible to have optimal characteristics of homogeneity of behavior of the tread band in the “cold” use conditions of the front tyre with a marked improvement of the driving and road holding performance in these use conditions.

Preferably, the ratio R2 between the tandelta of the second vulcanized elastomeric material of the lateral annular portions of the radially outer portion of the tread band, measured at a frequency of 10 Hz and at 70° C., and the tandelta of the first vulcanized elastomeric material of the central annular portion of the radially outer portion and of the radially inner portion of the tread band, measured at a frequency of 10 Hz and at 23° C., is comprised between 0.7 and 1.1.

In this way, it is advantageously possible to have optimal characteristics of “copying” on the ground of the tread band in the “hot” use conditions of the front tyre while maintaining or further improving drivability and road holding performance in these use conditions.

The shoulder area of the tread band of the front tyre in fact, is formed, from a point of view of its “hot” deformation capability, by a vulcanized elastomeric material that is substantially “homogeneous” from the point of view of its road behavior.

Preferably, the first vulcanized elastomeric material of the central annular portion of the radially outer portion and of the radially inner portion of the tread band has a dynamic elastic modulus E′, measured at a frequency of 10 Hz and at 23° C., comprised between 5.7 and 7.1 MPa, more preferably between 6.0 and 6.4 MPa.

In this way, it is advantageously possible to have adequate characteristics of rigidity and support of the radially inner portion of the tread band in the “cold” use conditions of the front tyre.

Preferably, the first vulcanized elastomeric material of the central annular portion of the radially outer portion and of the radially inner portion of the tread band has a tandelta, measured at a frequency of 10 Hz and at 23° C., comprised between 0.37 and 0.47, preferably between 0.41 and 0.45.

Advantageously, this preferred feature contributes to optimize and keep substantially constant or to improve the drivability and performance of the tyre in the “hot” use conditions of the front tyre on dry and/or hot surfaces when driving along a bend.

Preferably, the second vulcanized elastomeric material of the lateral annular portions of the radially outer portion of the tread band has a dynamic elastic modulus E′, measured at a frequency of 10 Hz and at 23° C., comprised between 5.2 and 6.5 MPa, more preferably between 5.6 and 6.0 MPa.

Advantageously, this preferred feature contributes to achieve an optimal homogeneity of the tread band of the front tyre so as to improve the drivability and performance of the tyre in the “cold” use conditions.

Preferably, the second vulcanized elastomeric material of the lateral annular portions of the radially outer portion of the tread band has a tandelta, measured at a frequency of 10 Hz and at 70° C., comprised between 0.34 and 0.44 MPa, more preferably between 0.38 and 0.40 MPa.

Advantageously, this preferred feature contributes to achieve optimal characteristics of “copying” on the ground of the tread band in the “hot” use conditions of the front tyre while maintaining or further improving drivability and road holding performance in these use conditions.

Preferably, the first vulcanized elastomeric material of the central annular portion of the radially outer portion and of the radially inner portion of the tread band is obtained by vulcanizing an elastomeric material comprising 100 phr of at least one elastomeric diene polymer and from 70 to 110 phr, more preferably from 80 to 100 phr, of a white reinforcing filler.

Preferably, the white reinforcing filler comprises an amount equal to or greater than 80%, more preferably equal to or greater than 85%, more preferably equal to or greater than 90%, more preferably equal to or greater than 95% by weight of the total weight of the reinforcing fillers, of an inorganic material selected from silica, alumina, silicates, hydrotalcite, calcium carbonate, kaolin, titanium dioxide and mixtures thereof.

Advantageously, this preferred feature contributes to achieve optimal wet grip characteristics in the “cold” use conditions of the front tyre.

Preferably, the second vulcanized elastomeric material of the lateral annular portions of the radially outer portion of the tread band is obtained by vulcanizing an elastomeric material comprising 100 phr of at least one elastomeric diene polymer and from 40 to 100 phr, more preferably from 50 to 90 phr, even more preferably from 60 to 80 phr of a carbon black reinforcing filler.

Preferably, the reinforcing filler comprises an amount equal to or greater than 75%, preferably equal to or greater than 80%, more preferably equal to or greater than 85%, more preferably equal to or greater than 90%, more preferably equal to or greater than 95% by weight of the total weight of the reinforcing fillers, of carbon black.

Advantageously, this preferred feature contributes to achieve optimal grip characteristics in the “hot” use conditions of the front tyre.

Preferably, the central annular portion of the radially outer portion of the tread band transversally extends along 5-25%, preferably along 10-20%, of an axial half-extension of the tread band.

In this way, it is advantageously possible to have optimal characteristics of rigidity and of road holding in the “cold” use conditions of the front tyre.

Preferably, an end proximal to the equatorial plane of the lateral annular portions of the radially outer portion of the tread band is arranged at a distance from the equatorial plane of at least 10% of an axial half-extension of the tread band itself.

In this way, it is advantageously possible to achieve optimal drivability and grip performance of the front tyre over a wide range of camber angles both on dry surfaces and on wet or humid surfaces.

In a preferred embodiment, each of the lateral annular portions of the radially outer portion of the tread band is arranged axially outside and adjacent to the central annular portion so as to define an interface that separates along the axial direction the central annular portion and the lateral annular portions.

In this way, it is advantageously possible to appropriately manage the transition along the axial direction between the first and the second vulcanized elastomeric material in the tread band so as to achieve the desired dynamic mechanical characteristics and behavior homogeneity of the front tyre.

In a preferred embodiment, the aforementioned interface can converge towards the equatorial plane of the tyre going from the inside to the outside of the tread band.

In this case, the aforementioned interface can be inclined with respect to the equatorial plane of the tyre by an angle preferably comprised between 30° and 50° and, more preferably, comprised between 35° and 40°.

In this way, it is advantageously possible to achieve a gradual transition along the axial direction between the first and the second vulcanized elastomeric material in the tread band achieving optimal dynamic mechanical characteristics and homogeneity of behavior of the front tyre.

In alternative preferred embodiments, the aforementioned interface can be parallel to the equatorial plane of the tyre or, still further, diverge going away from the equatorial plane going from the inside to the outside of the tread band.

In this case, the aforementioned interface can be inclined with respect to the equatorial plane of the tyre by an angle preferably comprised between 120° and 140° and, more preferably, comprised between 125° and 130°.

Preferably, the lateral annular portions of the radially outer portion of the tread band transversally extend along 75-95%, more preferably along 80-90%, of an axial half-extension of the tread band.

In this way, it is advantageously possible to optimize the drivability and grip performance of the front tyre over a wide range of camber angles both on dry surfaces and on wet or humid surfaces.

In a particularly preferred embodiment, the central annular portion of the radially outer portion of the tread band is substantially free of grooves.

In this way, it is advantageously possible to optimize the drivability and grip performance of the front tyre in wet or humid conditions thanks to the adhering capability of the first vulcanized elastomeric material of the central annular portion of the radially outer portion of the tread band.

Preferably, the lateral annular portions of the radially outer portion of the tread band each comprise a first lateral annular sub-portion, proximal to the equatorial plane of the tyre, and a second lateral annular sub-portion, distal with respect to the equatorial plane.

Preferably, the tyre comprises a plurality of grooves formed in the first lateral annular sub-portion of said lateral annular portions of the radially outer portion of the tread band.

The Applicant has experimentally found that thanks to these features there is a significant synergistic cooperation between the configuration of the tread pattern in the portions provided with grooves and the mechanical characteristics of stiffness of the tread band, having the “cap-and-base” structure defined above, in achieving optimal drivability and performance of the tyre on wet and/or cold ground.

Preferably, the first lateral annular sub-portion of the aforementioned lateral annular portions of the radially outer portion of the tread band transversally extends along 40-65%, more preferably along 45-60%, of the axial half-extension of the tread band.

In this way, it is advantageously possible to optimize the drivability and grip performance of the front tyre on wet or humid ground thanks to the ability of the lateral annular portions of the radially outer portion of the tread band, in particular of the first lateral annular sub-portion thereof to drain the water present under the ground-contacting area of the tyre in the areas of the tread band most used during the “cold” use conditions of the front tyre.

Preferably, the aforementioned plurality of grooves defines in the tread band an overall void to rubber ratio greater than or equal to 4% and less than or equal to 8%, more preferably greater than or equal to 4% and less than or equal to 5%.

In this way, it is advantageously possible to give an adequate stiffness to the tread band without limiting the draining capability thereof.

Preferably, the aforementioned plurality of grooves defines, in each first lateral annular sub-portion of the lateral annular portions of the radially outer portion of the tread band, a void to rubber ratio greater than or equal to 0% and less than or equal to 30%, more preferably greater than or equal to 0% and less than or equal to 25%.

In the present disclosure, the values of the void to rubber ratio are deemed to be calculated by dividing the radially outer portion of the tread band in annular regions having a predetermined transversal extension, for example of 5 mm, and by calculating the value of the ratio inside each annular region.

In this way, it is advantageously possible to achieve an optimal compromise between drivability and grip performance in the “cold” use conditions in wet or humid conditions and drivability and grip performance in the “hot” use conditions of the front tyre.

In a preferred embodiment, the aforementioned plurality of grooves defines, in a first annular sector, arranged axially outside and adjacent to the central annular portion, of each first lateral annular sub-portion of the lateral annular portions of the radially outer portion of the tread band, a void to rubber ratio increasing along the axial half-extension of the tread band and moving away from the equatorial plane of the tyre starting from the aforementioned interface.

Preferably, the aforementioned first annular sector transversally extends, from the end proximal to the equatorial plane of the lateral annular portions of the radially outer portion of the tread band, in other words from the circumferential line defined by the intersection between the plane passing through the interface and the radially outer surface of the tread band, which proximal end separates, along the axial direction, the central annular portion and the lateral annular portions of the radially outer portion of the tread band, along 5-25%, more preferably along 10-20%, of the axial half-extension of the tread band.

Preferably, in the aforementioned first annular sector, the void to rubber ratio increases from a minimum value of about 0% at the end proximal to the equatorial plane of the lateral annular portions of the radially outer portion of the tread band to a maximum value comprised between 20% and 30% at an axially outer end of the first annular sector.

Preferably, the axially outer end of the first annular sector is arranged at a distance from the equatorial plane of the tyre of at least 13% of the axial half-extension of the tread band.

More preferably, the axially outer end of the first annular sector is arranged at a distance from the equatorial plane of the tyre comprised between 15% and 35% of the axial half-extension of the tread band.

In this way, it is advantageously possible to optimize the drivability and grip performance in wet or humid conditions of the front tyre thanks to a synergistic cooperation between the configuration of the tread pattern and the mechanical hysteresis characteristics of the second vulcanized elastomeric material of the lateral annular portions of the radially outer portion of the tread band.

In particular, in the “cold” use conditions of the front tyre, the lateral annular portions of the radially outer portion of the tread band are capable of effectively draining the water present under the ground-contacting area of the tyre in the areas of the tread band most used during travel along a straight course and when driving along a bend, tendentially carried out at low camber angles, whereas the mechanical hysteresis characteristics of the tread band allow to have a homogeneous response to the stresses which the tyre is subjected to in these use conditions.

In a preferred embodiment, the aforementioned plurality of grooves defines, in a second annular sector, arranged axially outside and adjacent to the aforementioned first annular sector, of each first lateral annular sub-portion of the lateral annular portions of the radially outer portion of the tread band, a void to rubber ratio decreasing along the axial extension of the tread band and moving away from the equatorial plane of the tyre starting from the aforementioned first annular sector.

Preferably, the second annular sector transversally extends from the first annular sector along 15-60%, more preferably along 25-50%, of the axial half-extension of the tread band.

Preferably, in the second annular sector the void to rubber ratio decreases from a maximum value of about 25% at the axially outer end of the first annular sector to a minimum value equal to about 0% at an axially outer end of the first lateral annular sub-portion of the lateral annular portions of the radially outer portion of the tread band.

Advantageously, in this preferred embodiment of the invention, the reduction of the value of the void to rubber ratio progressively moving away from the equatorial plane of the tyre allows to fully exploit the hysteretic characteristics of the second vulcanized elastomeric material in case of demanding maneuvers and at high camber angles, conditions that can be reached in hot conditions during a race/on a racetrack.

In other words, in this preferred embodiment of the invention there is an effective synergistic interaction between the characteristics of the vulcanized elastomeric material of the radially outer portion and the characteristics of the tread pattern.

Preferably, the axially outer end of the first lateral annular sub-portion of the lateral annular portions of the radially outer portion of the tread band, coinciding with the axially outer end of the second annular sector, is arranged at a distance from the equatorial plane X-X of the tyre of at least 55%, more preferably of at least 60%, of the axial half-extension of the tread band.

In this way, it is advantageously possible to optimize the drivability and grip performance of the tyre in the “hot” use conditions and therefore not in the presence of a wet or humid surface when driving along a bend, which in this case is tendentially carried out at higher camber angles.

Preferably, the second lateral annular sub-portion of the lateral annular portions of the radially outer portion of the tread band transversally extends along 10-55%, more preferably along 20-45%, of an axial half-extension of the tread band of the tyre.

In a particularly preferred embodiment, each second lateral annular sub-portion of the aforementioned lateral annular portions of the radially outer portion of the tread band is substantially free of grooves.

In this way, it is advantageously possible to optimize the drivability and grip performance of the tyre in the “hot” use conditions and therefore not in the presence of a wet or humid surface when driving along a bend, which in this case is tendentially carried out at higher camber angles.

Preferably, the front motorcycle tyre of the invention has a transversal curvature ratio equal to or greater than 0.35 and equal to or less than 0.50, more preferably equal to or greater than 0.39 and equal to or less than 0.45 and, even more preferably, equal to or greater than 0.40 and equal to or less than 0.44.

### BRIEF DESCRIPTION OF THE FIGURES

Additional features and advantages of the invention will be better apparent from the following description of some preferred embodiments thereof, made hereinafter, for illustrative and not limiting purposes, with reference to the attached drawings.

Such drawings are schematic and are not to scale.

In the drawings:

FIG. 1 shows a perspective view of a front tyre according to a preferred embodiment of the invention;

FIG. 2 is an enlarged schematic view of a cross section of the front tyre of FIG. 1;

FIG. 3 is a graph that shows the trend of the void to rubber ratio along an axial half-extension of the front tyre of FIG. 1 also indicating the position of a circumferential line that separates, along the axial direction, a central annular portion and a lateral annular portion of the radially outer portion of the tread band; and

FIG. 4 is a schematic plan view of a portion of the tread band of the front tyre of FIG. 1.

### DETAILED DESCRIPTION OF CURRENTLY PREFERRED EMBODIMENTS

In the figures, reference numeral 1 generally indicates a front tyre for motorcycle wheels according to a preferred embodiment of the present invention. This concerns a tyre preferably intended to be used on a rear wheel of a motorcycle for a supersports motorcycle with large displacement, for example 600 cc, of the “Supersport” and/or “Hypersport” segment.

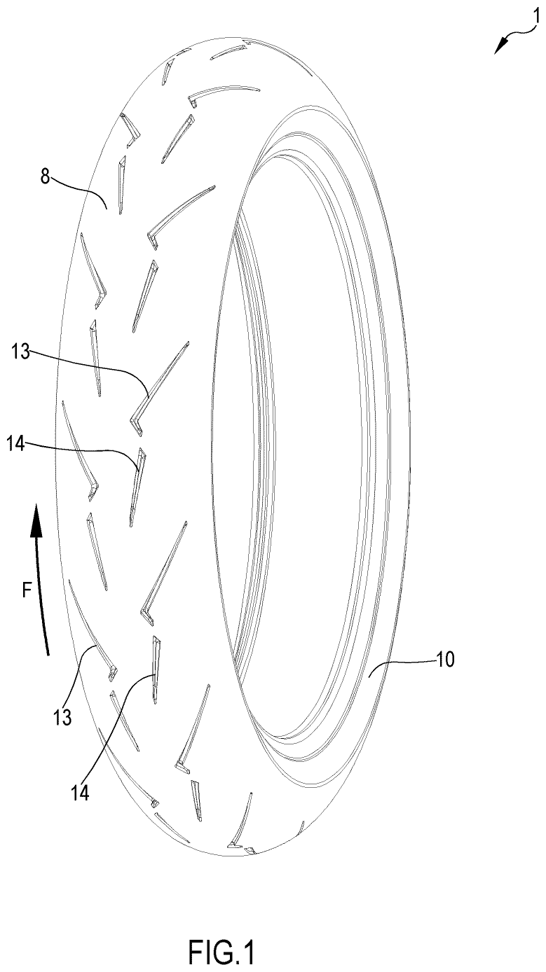

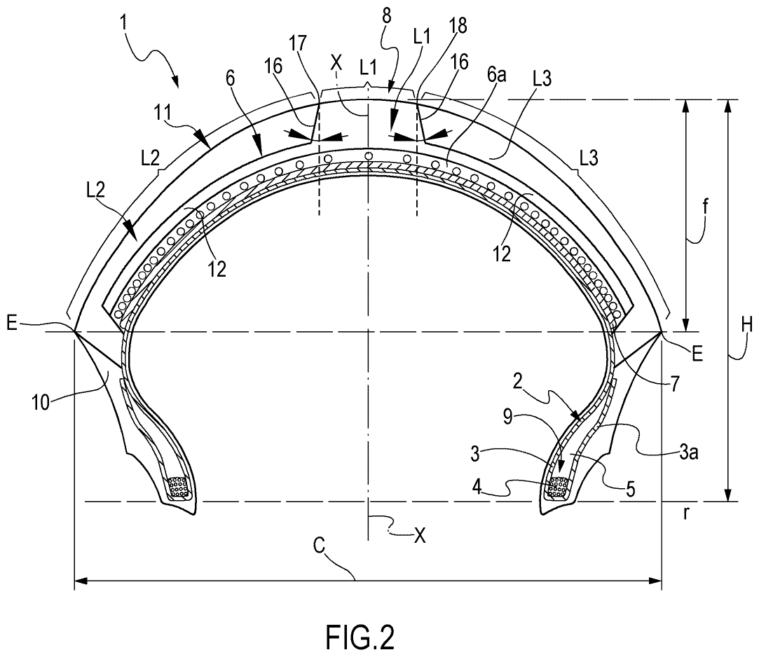

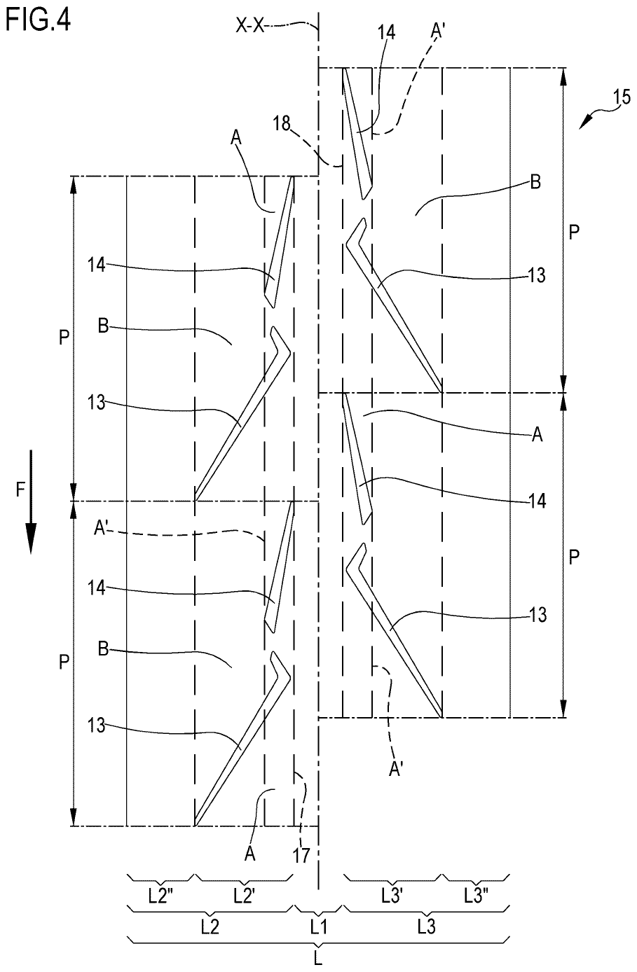

An equatorial plane X-X and a rotation axis (not shown) are defined in the tyre 1. A circumferential direction (indicated in FIGS. 1 and 4 by the arrow F oriented in the direction of rotation of the tyre 1) and an axial direction, indicated in FIG. 2 by the axis r perpendicular to the equatorial plane X-X are also defined.

The tyre 1 comprises a carcass structure 2 formed by at least one carcass layer 3 comprising a plurality of reinforcing elements (cords). In the embodiment illustrated in FIG. 1 there are two carcass layers 3.

The carcass structure 2 is typically coated on the inner walls thereof by a sealing layer, or so-called “liner”, essentially consisting of an airtight layer of elastomeric material, adapted to ensure the hermetic seal of the tyre itself once inflated.

The reinforcing elements, included in the carcass layer 3, preferably comprise textile cords made of fibrous material.

The fibrous material, used to manufacture the cords, can be made up of fibers of natural or synthetic origin selected among Rayon, Lyocell, polyesters (for example PEN, PET, PVA), aromatic polyamides (for example aramids such as Twaron®, Kevlar®), singularly or mixed. More specifically, the fibrous material for making the cords is preferably selected among Polyester, Rayon, Lyocell, aromatic polyamides or a hybrid formed by two or more of the aforementioned materials.

The reinforcing elements included in the at least one carcass layer 3 are preferably arranged in the radial direction, i.e. according to an angle comprised between 70° and 110°, more preferably between 80° and 100°, with respect to the circumferential direction.

The at least one carcass layer 3 is shaped according to a substantially toroidal configuration and is engaged, by means of its opposite circumferential edges 3a, with at least one annular reinforcing structure.

In particular, the opposite lateral edges 3a of the at least one carcass layer 3 can be turned around the annular reinforcing structures each comprising one or more metallic annular bead cores 4 and a tapered elastomeric filler 5 that occupies the space defined between the carcass layer 3 and the corresponding turned lateral edge 3a of the carcass layer 3.

The area of the tyre comprising the bead core 4 and the filling 5 forms the so-called bead 9 intended for anchoring the tyre 1 on a corresponding mounting rim, not illustrated.

In an embodiment that is not illustrated, the at least one carcass layer 3 is made by bringing together a plurality of strips of elastomeric material reinforced by the aforementioned cords and has the opposite lateral edges thereof associated without turning with special annular reinforcing structures provided with two annular inserts. A filler made of elastomeric material can be arranged at an axially outer position with respect to the first annular insert. A second annular insert can, on the other hand, be arranged at an axially outer position with respect to the end of the carcass layer. Finally, at an axially outer position with respect to said second annular insert, and not necessarily in contact therewith, it is possible to provide a further filler which finishes the manufacture of the annular reinforcing structure.

A belt structure 6 comprising at least one belt layer 6a typically formed by rubber-coated cords is circumferentially applied, at a radially outer position, on the carcass structure 2.

Preferably, the layer 6a is made by means of cords arranged substantially parallel and side-by-side to form a plurality of turns. Such turns are substantially oriented according to the circumferential direction (typically at an angle between 0° and 5°), such a direction usually being called “zero degrees” with reference to its laying arrangement with respect to the circumferential direction of the tyre.

Preferably, the layer 6a typically called “zero degrees” can comprise axially adjacent windings of a single cord or of a band of a rubber-coated fabric comprising axially adjacent cords.

The cords of the layer 6a are textile or metallic cords. Preferably, such cords are metallic, made of steel wires having a high carbon content, i.e. steel wires having a carbon content of at least 0.6-0.7%.

Preferably, such metal cords have a high elongation (HE).

In order to improve the adhesion between the belt structure 6 and the carcass structure 2 an adhesion layer 7 made of elastomeric material, not illustrated, interposed between the two aforementioned structures, may be provided.

In an embodiment that is not illustrated, the belt structure 6 can consist of at least two radially juxtaposed layers. The layers are arranged so that the cords of the first belt layer are obliquely oriented with respect to the circumferential direction of the tyre, whereas the cords of the second layer also have an oblique orientation, but substantially symmetrically crossed with respect to the cords of the first layer.

A tread band 8 is circumferentially overlaid on the belt structure 6, which tread band 8, after a molding operation carried out at the same time as the vulcanization of the tyre, typically has longitudinal and transversal grooves formed thereon, arranged to define a desired tread pattern.

FIGS. 1, 2 and 4 show, as a non-limiting example, a tread pattern comprising a plurality of grooves 13, 14 variously arranged on opposite sides of the equatorial plane X-X of the tyre 1 and that satisfies the requirements of the variation trend of the void to rubber ratio and of the grooves distribution in accordance with a preferred embodiment of the front tyre 1 of the present invention.

As better illustrated in FIG. 4, the tread pattern comprises a module 15 which is repeated along a direction of circumferential development of the tyre 1.

In the preferred embodiment of the front tyre 1 illustrated in FIG. 4, the module 15 comprises 2 pitches P circumferentially offset from one another on opposite sides of the equatorial plane X-X of the tyre 1.

The aforementioned module 15, in the case of a tyre intended to be mounted on the front wheel of a motorcycle, such as the one object of the present invention, is repeated at least 10 times along the circumferential development of the tyre 1. Preferably, at least 12 times, for example 14 times.

Preferably, the tread pattern comprises a first circumferential succession of first grooves 13 having a substantially L-shape and preferably having a portion of prevalent length tapered along the preferential rolling direction F of the tyre 1.

Preferably, the tread pattern comprises a second circumferential succession of second grooves 14 circumferentially interposed between the first grooves 13 and preferably tapered along a direction opposite to the preferential rolling direction F of the tyre 1.

Preferably, both the first grooves 13 and the second grooves 14 are inclined with respect to the equatorial plane X-X of the tyre 1.

For the sake of simplicity, the grooves 13, 14 are not represented in FIG. 2.

The tyre 1 can comprise a pair of sidewalls 10 laterally applied on opposite sides to said carcass structure 2.

The tyre 1 has a section height H measured, on the equatorial plane X-X, between the top of the tread band 8 and the fitting diameter, identified by the reference line r, passing through the beads of the tyre 1.

The tyre 1 further has a cross section maximum width C defined by the distance between the axially opposite ends E of the profile of the tread band 8, and a curvature ratio, defined as the ratio between the distance f of the top of the tread band 8 from the line passing through the ends E of the tread band 8 itself, measured at the equatorial plane of the tyre 1 and the aforesaid maximum width C. The axially opposite ends E of the tread band 8 may be formed by a corner.

In particular, the tyre 1 has a cross section characterized by a high curvature ratio, preferably a transversal curvature ratio f/C equal to or greater than 0.35 and equal to or less than 0.50, more preferably equal to or greater than 0.39 and equal to or less than 0.45 and, even more preferably, equal to or greater than 0.40 and equal to or less than 0.44.

In a preferred embodiment, the front motorcycle tyre 1 of the invention is intended to be mounted on the front wheel having chord dimensions substantially comprised between 100 and 130 mm.

Preferably, the distance f between the radially outer point of the tread band 8 and the line passing through the axially opposite ends E of the tread band 8 itself of the tyre 1 is substantially comprised between 47 and 55 mm.

Preferably, the total height/chord H/C ratio is substantially comprised between 0.60 and 0.70.

In preferred embodiments, the tyres 1 allow better performance when they have sidewalls 10 of appreciable height, for example, having values of the sidewall height (H-f)/H ratio equal to or greater than 0.3, more preferably equal to or greater than 0.35.

According to the invention, the tread band 8 is of the so-called “cap-and-base” type and is made with two different vulcanized elastomeric materials having the characteristics described above.

In the preferred embodiment illustrated in the figures, the tread band 8 has an overall axial extension L and comprises:
a) a radially outer portion 11 comprising:
   a1) a central annular portion L1 arranged astride the equatorial plane X-X of the tyre 1, and
   a2) a pair of lateral annular portions L2, L3, arranged at opposite sides of the central annular portion L1 with respect to the equatorial plane X-X of the tyre 1.

As outlined above, the central annular portion L1 is made with the aforementioned first vulcanized elastomeric material, whereas the lateral annular portions L2, L3 of the tread band 8 are made with the second vulcanized elastomeric material described above.

In the preferred embodiment illustrated in the figures, the tread band 8 comprises a radially inner portion 12 extending below the radially outer portion 11 of the tread band 8 and along the entire axial extension thereof.

As outlined above, the radially inner portion 12 of the tread band 8 is made with the aforementioned first vulcanized elastomeric material.

Preferably, the central annular portion L1 of the tread band 8 has an axial extension L1 that transversally extends along 5-25%, more preferably along 10-20%, of an axial half-extension L/2 of the tread band 8.

Preferably, the lateral annular portions L2, L3 of the tread band 8 have a respective axial extension that transversally extends along 75-95%, more preferably along 80-90%, of the axial half-extension L/2 of the tread band 8.

Preferably and as better illustrated in FIG. 4, the lateral annular portions L2, L3 of the radially outer portion 11 of the tread band 8 each comprise a first lateral annular sub-portion L2′, L3′, proximal with respect to the equatorial plane X-X, and a second lateral annular sub-portion L2″, L3″, distal with respect to the equatorial plane X-X of the tyre 1.

Preferably, the grooves 13, 14 are formed in the first lateral annular sub-portion L2′, L3′ of the lateral annular portions L2, L3 of the radially outer portion 11 of the tread band 8 of the tyre 1.

Preferably, each first lateral annular sub-portion L2′, L3′ of the lateral annular portions L2, L3 of the radially outer portion 11 of the tread band 8 is arranged axially outside and adjacent to the central annular portion L1 so as to define an interface 16 that separates, along the axial direction, the central annular portion L1 and the lateral annular portions L2, L3.

Within the framework of the invention, the interface 16 also constitutes a separating interface along the axial direction between the first vulcanized elastomeric material that constitutes the central annular portion L1 of the radially outer portion 11 and the second vulcanized elastomeric material that constitutes the lateral annular portions L2, L3 of the radially outer portion 11 of the tread band 8.

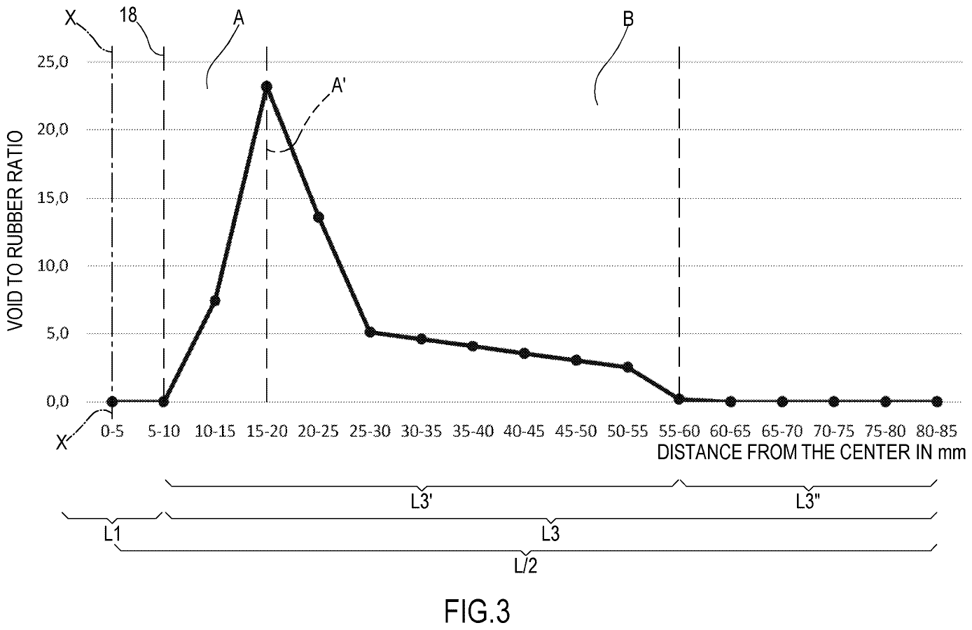

The intersection between the plane passing through the interface 16 and the radially outer surface of the tread band 8 defines, on opposite sides of the equatorial plane X-X, a pair of circumferential lines 17, 18 (see FIGS. 3 and 4) which identify the end proximal to the equatorial plane X-X of the lateral annular portions L2, L3 of the radially outer portion 11 of the tread band 8.

Preferably, the lateral annular portions L2, L3 of the radially outer portion 11 of the tread band 8 and, therefore, the circumferential lines 17, 18, are arranged at a distance from the equatorial plane X-X of the tyre 1, as defined above, of at least 10% of an axial half-extension L/2 of the tread band 8.

Preferably, the first lateral annular sub-portion L2′, L3′ of the lateral annular portions L2, L3 of the radially outer portion 11 of the tread band 8 transversally extends along 40-65%, preferably along 45-60%, of the axial half-extension L/2 of the tread band 8.

Preferably, the central annular portion L1 of the radially outer portion 11 is integral with the radially inner portion 12 of the tread band 8, for example by depositing contiguous circumferential coils of at least one continuous elongated element of the aforementioned first vulcanized elastomeric material.

Preferably, the lateral annular portions L2, L3 of the tread band 8 are also formed in one piece, for example by depositing contiguous circumferential coils of at least one continuous elongated element of the aforementioned second vulcanized elastomeric material.

In this way and as outlined above, a pair of interfaces 16 between the first and the second vulcanized elastomeric material are defined in the radially outer portion 11 of the tread band 8, and on opposite sides of the equatorial plane X-X of the tyre 1 and of the central annular portion L1.

In the preferred embodiment shown in FIG. 2, the interfaces 16 can converge towards the equatorial plane X-X of the tyre 1 going from the inside towards the outside of the tread band 8 and being oriented according to a direction inclined with respect to the equatorial plane X-X at an angle comprised between 30° and 50°, preferably between 35° and 40°.

Preferably, the interfaces 16 are symmetrically arranged with respect to the equatorial plane X-X of the tyre 1. In this case, the aforementioned angles of inclination of the interfaces 16 are deemed to be measured from the equatorial plane X-X and in opposite directions, as schematically illustrated in FIG. 2.

In this preferred configuration of the tread band 8, the radially inner portion 12 of the tread band 8 extends substantially along the entire overall axial extension of the belt structure 6.

In this preferred configuration of the tread band 8, therefore, the radially inner portion 12 of the tread band 8 is interposed in the radial direction between the belt structure 6 and the lateral annular portions L2, L3 of the radially outer portion 11 of the tread band 8.

Preferably, the grooves 13, 14 define, in the tread band 8, an overall void to rubber ratio greater than or equal to 4% and less than or equal to 8%, preferably greater than or equal to 4% and less than or equal to 5%.

Preferably, the grooves 13, 14 define, in each first lateral annular sub-portion L2′, L3′ of the lateral annular portions L2, L3 of the radially outer portion 11 of the tread band 8, a void to rubber ratio greater than or equal to 0% and less than or equal to 30%, preferably greater than or equal to 0% and less than or equal to 25%.

As outlined above, the aforementioned values of the void to rubber ratio in each first lateral annular sub-portion L2′, L3′ are deemed to be calculated by dividing the radially outer portion 11 of the tread band 8 into annular regions having a transversal extension for example of 5 mm and by calculating the value of the ratio inside each annular region.

FIG. 3 shows, as an example with reference to one of the two axial half-extensions L/2 of the tread band 8, a graph which illustrates the position of the circumferential line 18 defined by the interface 16 with the radially outer surface of the tread band 8 and the trend of the void to rubber ratio of the tread band 8 in a half-portion of a front tyre 1 according to the preferred embodiment described herein.

It should be understood that in the half-portion of the front tyre 1 arranged on the opposite side with respect to the equatorial plane X-X there is a mirroring trend of the aforementioned void to rubber ratio.

In FIG. 3, the circumferential line 18 separates, along the axial direction, the central annular portion L1 formed by the first vulcanized elastomeric material and the lateral annular portion L3 formed by the second vulcanized elastomeric material.

The X-axis thus shows, expressed in mm, the distance with respect to the equatorial plane X-X and the Y-axis shows the void to rubber ratio.

The solid line represents the trend of the void to rubber ratio of the front tyre 1 according to the preferred embodiment illustrated.

Preferably, the tyre 1 has a void to rubber ratio that is variable along the axial extension between a minimum value substantially equal to zero at the circumferential line 17, 18 and a maximum value arranged in the first lateral annular sub-portion L2′, L3′ of the lateral annular portions L2, L3 of the radially outer portion 11 of the tread band 8.

More particularly and as is better illustrated in FIG. 3 with reference to one of the two half-portions of the front tyre 1, the grooves 13, 14 define in each first lateral annular sub-portion L2′, L3′ of the lateral annular portions L2, L3 of the radially outer portion 11 of the tread band 8, a void to rubber ratio increasing along the axial half-extension L/2 of the tread band 8 and going away from the equatorial plane X-X of the tyre 1 starting from the circumferential line 17, 18.

Advantageously, the position of the interface 16 between the central annular portion L1 and each first lateral annular sub-portion L2′, L3′ of the lateral annular portions L2, L3 of the radially outer portion 11 of the tread band 8, at which the grooves 13, 14 are positioned, allows to obtain suitable “mobility” characteristics of the solid portions defined in the tread band 8 between the grooves 13, 14.

These “mobility” characteristics of the solid portions are advantageously adapted to “heat” the second vulcanized elastomeric material in the “cold” use conditions of the tyre 1 with a substantial performance improvement in these use conditions.

Preferably and as is better illustrated in FIG. 3, the grooves 13, 14 define, in a first annular sector A, arranged axially outside and adjacent to the central annular portion L1, of each first lateral annular sub-portion L2′, L3′ of the lateral annular portions L2, L3 of the radially outer portion 11 of the tread band 8, a void to rubber ratio increasing along the axial extension of the tread band 8 and moving away from the equatorial plane X-X of the tyre 1 starting from the circumferential lines 17, 18 defined by the interface 16.

Preferably, the first annular sector A transversally extends starting from the circumferential line 17, 18 along 5-25%, preferably along 10-20%, of the axial half-extension L/2 of the tread band 8.

Preferably, in the first annular sector A the void to rubber ratio increases from a minimum value of about 0% at the circumferential line 17, 18 defined by the interface 16 to a maximum value comprised between 20% and 30% at an axially outer end A′ of the first annular sector A.

Preferably, the axially outer end A′ of the first annular sector A is arranged at a distance from the equatorial plane X-X of the tyre 1 of at least 13% of the axial half-extension L/2 of the tread band 8.

More preferably, the axially outer end A′ of the first annular sector A is arranged at a distance from the equatorial plane X-X of the tyre 1 comprised between 15% and 35% of the axial half-extension L/2 of the tread band 8.

Preferably and as is better illustrated in FIG. 3, the grooves 13, 14 define, in a second annular sector B, arranged axially outside and adjacent to the first annular sector A, of each first lateral annular sub-portion L2′, L3′ of the lateral annular portions L2, L3 of the radially outer portion 11 of the tread band 8, a void to rubber ratio decreasing along the axial extension of the tread band 8 and moving away from the equatorial plane X-X of the tyre 1 starting from the aforementioned first annular sector A.

Preferably, the second annular sector B transversally extends from the first annular sector A along 15-60%, more preferably along 25-50%, of the axial half-extension L/2 of the tread band 8.

Preferably, in the second annular sector B the void to rubber ratio decreases from a maximum value of about 25% at the axially outer end A′ of the first annular sector A to a minimum value equal to about 0% at an axially outer end of the first lateral annular sub-portion L2′, L3′ of the lateral annular portions L2, L3 of the radially outer portion 11 of the tread band 8.

Preferably, the axially outer end of the first lateral annular sub-portion L2′, L3′ of the lateral annular portions L2, L3 of the radially outer portion 11 of the tread band 8, coinciding with the axially outer end of the second annular sector B, is arranged at a distance from the equatorial plane X-X of the tyre 1 of at least 55%, more preferably of at least 60%, of the axial half-extension L/2 of the tread band 8.

Preferably, the second lateral annular sub-portion L2″, L3″ of the lateral annular portions L2, L3 of the radially outer portion 11 of the tread band 8 transversally extends along 10-55%, more preferably along 20-45%, of the axial half-extension L/2 of the tread band 8 of the tyre 1.

Preferably, each second lateral annular sub-portion L2″, L3″ of the lateral annular portions L2, L3 of the radially outer portion 11 of the tread band 8 is substantially free of grooves.

The compounds for the different portions of the tread band 8 as well as for the other semi-worked products forming the tyre 1 comprise at least one elastomeric diene polymer (a1).

Advantageously, such rubber compounds comprise at least one alfa-olefin and have specific formulations as will be detailed more hereinafter.

According to an embodiment, said at least one elastomeric diene polymer (a1) can be selected for example from elastomeric diene polymers commonly used in elastomeric compositions cross-linkable with sulfur (vulcanization), which are particularly suitable for the production of tyres, i.e. from elastomeric polymers or copolymers with an unsaturated chain having a glass transition temperature (Tg) normally below 20° C., preferably in the range between 0° C. and −110° C. These polymers or copolymers can be of natural origin or can be obtained by polymerization in solution, polymerization in emulsion or gas phase polymerization of one or more conjugated diolefins, optionally mixed with at least one comonomer selected from monovinylarenes and/or polar comonomers.

For the tread rubber compound, polybutadiene (BR) and/or styrene-butadiene polymers (SBR), for example SSBR (styrene butadiene elastomer from solution), as such or in mixture, are preferably used.

Preferably, the styrene-butadiene polymer (SBR) can be present in the rubber compounds of the present invention in variable amounts from about 50 to 100 phr, more preferably from 70 to 100 phr.

Advantageously, polybutadiene (BR) can be absent or can be included in the rubber compounds of the present invention and in particular in the tread rubber compound in an amount from about 0 phr to 40 phr, more preferably from about 10 to 30 phr.

Preferably, the styrene-butadiene polymer can by obtained by solution polymerization and generally comprises styrene in an amount from about 10% to 40% by weight, preferably from about 15% to 30% by weight.

Preferably, the styrene-butadiene polymer can have low molecular weight, having an average molecular weight Mn of less than 200.000 g/mol, preferably comprised between 150.000 and 200.000 g/mol.

The elastomeric material of the different portions of the tread band 8, comprises at least one reinforcing filler that in the case of the vulcanized elastomeric material is preferably a white filler like silica, alumina, silicates, hydrotalcite, calcium carbonate, kaolin, titanium dioxide and mixtures thereof, and in the case of the second vulcanized elastomeric material is preferably and prevalently a carbon black filler.

Such reinforcing fillers are present in the respective vulcanized elastomeric materials in an amount generally comprised between 40 phr and 130 phr.

Preferably, the first vulcanized elastomeric material of the central annular portion L1 of the radially outer portion 11 of the tread band 8 is obtained by vulcanizing an elastomeric compound comprising 100 phr of at least one elastomeric diene polymer and from 70 to 110 phr, more preferably from 80 to 100 phr, of a white reinforcing filler.

In a preferred embodiment, the first vulcanized elastomeric material of the central annular portion L1 of the radially outer portion 11 of the tread band 8 comprises an amount greater than 70%, more preferably equal to or greater than 80%, more preferably equal to or greater than 85%, more preferably equal to or greater than 90%, more preferably equal to or greater than 95% by weight of the total weight of the reinforcing fillers, of a “white” reinforcing filler as defined above.

More preferably, such a “white” reinforcing filler is selected from silica, alumina, silicates, hydrotalcite, calcium carbonate, kaolin, titanium dioxide, and mixtures thereof.

Even more preferably, the “white” reinforcing filler can be a pyrogenic silica or a precipitated silica, with a BET surface area (measured according to ISO Standard 5794/1) comprised between 50 m²/g and 500 m²/g, more preferably between 70 m²/g and 200 m²/g.

In this way, it is advantageously possible to achieve a rapid warm-up of the tread band 8 of the tyre 1, as well as excellent grip in different conditions of the road surface.

Preferably, the second vulcanized elastomeric material of the lateral annular portions L2, L3 of the radially outer portion 11 of the tread band 8 is obtained by vulcanizing an elastomeric compound comprising 100 phr of at least one elastomeric diene polymer and from 40 to 100 phr, more preferably from 50 to 90 phr, even more preferably from 60 to 80 phr of a carbon black reinforcing filler.

In a preferred embodiment, the second elastomeric material of the lateral annular portions L2, L3 of the radially outer portion 11 of the tread band 8 comprises an amount greater than 75%, more preferably equal to or greater than 80%, more preferably equal to or greater than 85%, more preferably equal to or greater than 90%, more preferably equal to or greater than 95% by weight of the total weight of the reinforcing fillers, of carbon black. Preferably, the carbon black is selected from those having a surface area of not less than 20 m²/g, preferably more than 50 m²/g (determined by STSA—statistical thickness surface area according to ISO 18852:2005).

The carbon black can be, for example, N234, N326, N330, N375 or N550, N660 marketed by Birla Group (India) or CRX 1391 from Cabot Corporation.

The reinforcing filler can comprise mixtures, for example of carbon black and silica.

In this way, it is advantageously possible to optimize the value of the dynamic elastic modulus E′ of the second elastomeric material as a function of the expected temperature values during use of the tyre 1.

The elastomeric compositions described earlier and those of the other components of the tyre 1 can be vulcanized according to known techniques, in particular with sulfur-based vulcanization systems, commonly used for elastomeric polymers. For this purpose, in the elastomeric composition, after one or more thermomechanical treatment steps, a sulfur-based vulcanizing agent is incorporated together with vulcanization accelerants. In the final step of the treatment, the temperature is kept generally below 140° C., so as to avoid any undesired pre-cross-linking phenomena.

The vulcanizing agent most advantageously used is sulfur, or molecules containing sulfur (sulfur donors), with accelerants and activators known to those skilled in the art.

Activators that are particularly effective are zinc-based compounds, and in particular ZnO, ZnCO₃, zinc salts of saturated or unsaturated fatty acids containing from 8 to 18 carbon atoms, such as, for example, zinc stearate, which are formed preferably in situ in the elastomeric composition from ZnO and fatty acid, and also BiO, PbO, Pb₃O₄, PbO₂, or mixtures thereof.

Accelerants that are commonly used may be selected from: dithiocarbamates, guanidine, thiourea, thiazoles, sulfenamides, thiurams, amines, xanthates, or mixtures thereof.

The elastomeric compositions used can comprise other additives commonly selected based on the specific application for which each composition is intended.

For example, the following additives can be added to said elastomeric compositions: antioxidants, anti-ageing agents, plasticizers, adhesives, antiozonants, modifying resins, fibers (aramid or of natural origin), or mixtures thereof.

The following Table 1, gives an example, purely for illustration purposes, of the elastomeric compositions that make the first and the second vulcanized elastomeric material after vulcanization in a preferred embodiment of the front tyre 1.

The amounts of the various components of the elastomeric compositions are given in phr as defined above.

TABLE 1

| | First elastomeric material | Second elastomeric |
|---|---|---|
| | (central annular portion | material (lateral |
| | of the radially outer portion | annular portions of the |
| | and of the radially inner | radially outer portion |
| Component | portion of the tread band) | of the tread band) |
| S-SBR | 70-85* | 100* |
| BR | 15-30 | — |
| CB | 10-30 | 60-80 |
| Silica | 80-100 | — |
| Liquid copolymer | — | 10-20 |
| Extension oil of | 26-32 | 37.5-40 |
| the SBR polymers | | |
| and free oil | | |
| Lubricant | 10-20 | 15-25 |
| Resin 1 | 15-25 | 10-20 |
| Resin 2 | 5-10 | 10-20 |
| Zinc salt | 3-5 | — |
| Stearic acid | — | 1-2 |
| Zinc oxide | — | 2.5 |
| Silane | 6-8 | 1-2 |
| Zinc stearate | 2-3 | 1-2 |
| Wax | 1-1.5 | 0-1.5 |
| Antioxidant | 1-2 | 1-2 |
| Antiozonant | 2-3 | 2-3 |
| Sulfur | 1-2 | 1-2 |
| Cross-linker | — | 3-4 |
| Vulcanization | 2-3 | — |
| accelerant 1 | | |
| Vulcanization | 1-2 | 2-3 |
| accelerant 2 | | |
| Vulcanization | 0-1 | 0.5-1 |
| accelerant 3 | | |
| Vulcanization | — | 0.3 |
| retardant | | |

*phr of dry polymer without extension oil

S-SBR: styrene-butadiene copolymer polymerized in solution (phr given as dry polymer, extended with 37.5 phr of TDAE oil every 100 phr of dry elastomeric polymer—TUFDENE E680 (Asahi Kasei)
BR: low cis functionalized polybutadiene—YB03 (Asahi Kasei)
CB: CRX™ 1391 (Cabot)
Silica: ULTRASIL® 7000 (Evonik)
Liquid copolymer (grip enhancer): Low molecular weight butadiene/styrene liquid copolymer (4500 g/mol)—RICON® 100 (Cray Valley)
Extension oil: TDAE (Orgkhim)
Lubricant: tris(2-ethylhexyl)phosphate (TOF) (Lanxess)
Resin 1: hydrocarbon resin—KRISTALEX® 5140LV (Flexys)
Resin 2: hydrocarbon resin—RHENOSIN® TT 90 (Lanxess)
Zinc salt: Zinc neodecanoate 50 (Rhein Chemie)
Stearic acid: Stearic acid (Undesa)
Zinc oxide: RHENOGRAN® ZnO (Zincol Ossidi)
Silane: SILAN (Evonik)
Zinc stearate: ACID GRAS SARE DE ZINC (Eigemann & Veronelli)
Wax: WAX (Repsol)
Antioxidant: 2,2,4-Trimethyl-1,1-dihydroquinoline—TMQ (Lanxess)
Antiozonant: N-(1,3-dimethylbutyl)-N′-phenyl-p-phenylenediamine-SANTOFLEX® 6PPD (Eastman)
Sulfur: RHENOCURE® IS 90 P (Rhein Chemie)
Cross-linker: bifunctionalized 1,6-bis(NN′-dibenzyl thiocarbamoyldithio)-hexane—VULCUREN® KA 9188 (Lanxess)
Vulcanization accelerant 1: N-tert-butyl-benzothiazole sulfenamide—TBBS (Huatai Chemicals)
Vulcanization accelerant 2: dibenzothiazole disulfide—RHENOGRAN® MBTS 80 (Rhein Chemie)
Vulcanization accelerant 3: Tetrabenzyl thiuram disulfide—TBZTD (Akrochem)
Vulcanization retardant: N-(Cyclohexylthio)phthalimide—PVI (Akrochem)

Preferably, the first vulcanized elastomeric material of the central annular portion L1 of the radially outer portion 11 and of the radially inner portion 12 of the tread band 8 has a dynamic elastic modulus E′, measured at a frequency of 10 Hz and at 23° C., comprised between 5.7 and 7.1 MPa, more preferably between 6.0 and 6.4 MPa.

Moreover, the first vulcanized elastomeric material of the central annular portion L1 of the radially outer portion 11 and of the radially inner portion 12 of the tread band 8 has a tandelta, measured at a frequency of 10 Hz and at 23° C., comprised between 0.37 and 0.47, preferably between 0.41 and 0.45.

In accordance with the invention, the ratio R1 between the dynamic elastic modulus E′ of the second vulcanized elastomeric material of the lateral annular portions L2, L3 of the radially outer portion 11 of the tread band 8, measured at a frequency of 10 Hz and at 23° C., and the dynamic elastic modulus E′ of the first vulcanized elastomeric material of the central annular portion L1 of the radially outer portion 11 and of the radially inner portion 12 of the tread band 8, measured at a frequency of 10 Hz and at 23° C., is comprised between 0.6 and 1.2, preferably between 0.7 and 1.1.

Moreover, the ratio R2 between the tandelta of the second vulcanized elastomeric material of the lateral annular portions L2, L3 of the radially outer portion 11 of the tread band 8, measured at a frequency of 10 Hz and at 70° C., and the tandelta of the first vulcanized elastomeric material of the central annular portion L1 of the radially outer portion 11 and of the radially inner portion 12 of the tread band 8, measured at a frequency of 10 Hz and at 23° C., is comprised between 0.6 and 1.2, preferably between 0.7 and 1.1.

As outlined above, the Applicant has experimentally observed that by controlling to values close to one the aforementioned ratios R1 between the characteristics of stiffness—correlated to the values of dynamic elastic modulus E′—as well as R2 between the characteristics of hysteresis—correlated to the values of tandelta—it is advantageously possible to have, in the “hot” use conditions of the tyre, optimal dynamic and hysteretic behavior and, at the same time, an improvement of drivability and grip performance on the road in the “cold” use conditions.

The front tyre 1 can also be provided with one or more of the preferred features described above achieving the corresponding advantageous technical effects.

The invention will now be illustrated by some Examples to be considered for illustrating and not limiting purposes thereof.

### Properties of Vulcanized Elastomeric Compositions

The following Table 2, gives an example, purely for illustration purposes, of elastomeric compositions that make the first and the second vulcanized elastomeric material after vulcanization in a particularly preferred embodiment of the front tyre 1.

The amounts of the various components of the elastomeric compositions are provided in phr, whereas the ingredients are as defined at the bottom of preceding Table 1.

TABLE 2

| | First elastomeric material | Second elastomeric |
|---|---|---|
| | (central annular portion | material (lateral |
| | of the radially outer portion | annular portions of the |
| | and of the radially inner | radially outer portion |
| Component | portion of the tread band) | of the tread band) |
| S-SBR | 80* | 100* |
| BR | 20 | — |
| CB | 15 | 75 |
| Silica | 85 | — |
| Liquid copolymer | — | 20 |
| Extension oil of | 30 | 37.5 |
| the SBR polymers | | |
| Lubricant | 15 | 20 |
| Resin 1 | 20 | 15 |
| Resin 2 | 8 | 15 |
| Zinc salt | 4 | — |
| Stearic acid | — | 1.5 |
| Zinc oxide | — | 2.5 |
| Silane | 7 | 1.5 |
| Zinc stearate | 2.5 | 2 |
| Wax | 1 | — |
| Antioxidant | 1 | 2 |
| Antiozonant | 3 | 2.5 |
| Sulfur | 1.3 | 1.5 |
| Cross-linker | — | 3.5 |
| Vulcanization | 2.5 | — |
| accelerant 1 | | |
| Vulcanization | 1.5 | 2.5 |
| accelerant 2 | | |
| Vulcanization | — | 1.0 |
| accelerant 3 | | |
| Vulcanization | | 0.3 |
| retardant | | |

*phr of dry polymer without extension oil

The following Table 3 gives the results of the static and dynamic mechanical analyses carried out on samples of the compositions used for the aforementioned first vulcanized elastomeric material of the central annular portion L1 of the radially outer portion 11 and of the radially inner portion 12, and second vulcanized elastomeric material of the lateral annular portions L2, L3 of the radially outer portion 11 of the tread band 8 of a front tyre 1 according to the invention, the formulation of which has been indicated in preceding Table 2.

These analyses were carried out at the temperature and frequency conditions and with the methods indicated earlier.

TABLE 3

| | |
|---|---|
| First elastomeric material | Second elastomeric |
| (central annular portion | material (lateral |
| of the radially outer portion | annular portions of the |
| and of the radially inner | radially outer portion |
| portion of the tread band) | of the tread band) |

Static characteristics

| | | |
|---|---|---|
| CA1 (MPa) | 1.5 | 1.2 |
| CA3 (MPa) | 7.8 | 6.1 |

Dynamic characteristics

| | | |
|---|---|---|
| E′ 23° C. - | 6.368 | 5.830 |
| 10 Hz (MPa) | | |
| Tandelta 23° C. - | 0.427 | 0.681 |
| 10 Hz | | |
| Tandelta 70° C. - | — | 0.387 |
| 10 Hz | | |

CA1: load at a 100% elongation
CA3: load at a 300% elongation

The following Table 4 gives the ratios R1 between the dynamic mechanical characteristics of elastic modulus E′ and R2 of tandelta indicated earlier between the various vulcanized elastomeric materials and in each vulcanized elastomeric material as far as they are of interest for the purposes of the present invention.

TABLE 4
Ratios between different materials (the
parameter of interest in brackets)

| | |
|---|---|
| “cold” R1 (E′ moduli) | 0.91 |
| “hot” R2 (tandelta) | 0.91 |

From Table 4 it can clearly be seen that the values of the ratios R1 and R2 close to 1 are predictive of a homogeneous behavior, respectively, both in the “cold” and in the “hot” use conditions between the second and the first vulcanized elastomeric material.

In this way and as outlined above, such vulcanized elastomeric materials allow to maintain optimal drivability and grip performance use conditions in the “hot” use conditions and, at the same time, to improve the drivability and grip performance in the “cold” use conditions of the front tyre as will be illustrated in more detail hereinafter with reference to the tests carried out outdoors on a comparative tyre and on a tyre according to the invention.

### Outdoor Tests on Tyres

The Applicant, with the aim of improving performance took as base for the comparative driving tests supersports tyres for a front wheel of size 120/70ZR17 having a transversal curvature ratio equal to about 0.42.

The tyre according to the invention had a “cap-and-base” configuration of the tread band as described above with reference to FIG. 2. In such a tyre the compounds given in Table 2 with the mechanical characteristics given in Tables 3 and 4 were used to make the tread band.

The performance of such a tyre was compared with that of a comparative tyre of analogous size and construction but that differed only by the configuration and composition of the tread band.

In this case, the comparative tyre for a front wheel was for racetrack use and approved for road use and had a configuration of the tread band of the single-compound type, conventional for this type of tyre.

The tread band of the comparative tyre was made with the material given in the following Table 5.

TABLE 5
Comparative tyre

| Component | Single elastomeric material of the tread band |
|---|---|
| S-SBR 1 | 98 |
| S-SBR 2 | 40 |
| CB | 80 |
| Extension oil | 15 |
| Resin 1 | 14 |
| Resin 2 | 1.5 |
| Stearic acid | 1.5 |
| Zinc oxide | 5 |
| Antiozonant | 2 |
| Sulfur | 2.5 |
| Vulcanization accelerant | 2.5 |
| Vulcanization retardant | 0.2 |

* phr of dry polymer without extension oil

S-SBR 1: styrene-butadiene copolymer polymerized in solution (phr given as dry polymer, extended with 37.5 phr of TDAE oil every 100 phr of dry elastomeric polymer—SBR 1789 (Synthos)
S-SBR 2: styrene-butadiene copolymer polymerized in solution (phr given as dry polymer, extended with 37.5 phr of TDAE oil every 100 phr of dry elastomeric polymer—HP755 (JSR)
CB: CRX™ 1391 (Cabot)
Extension oil: TDAE (Nynas)
Resin 1: hydrocarbon resin—KRISTALEX® F85 (Flexys)
Resin 2: hydrocarbon resin—RASINA BM01 (SER)
Stearic acid: Stearic acid (Wilmar)
Zinc oxide: RHENOGRAN® ZnO (Zincol Ossidi)
Antiozonant: N-(1,3-dimethylbutyl)-N′-phenyl-p-phenylenediamine—SANTOFLEX® 6PPD (Eastman)
Sulfur: RHENOCURE® IS 90 P (Rhein Chemie)
Vulcanization accelerant: N-tert-butyl-benzothiazole sulfenamide—TBBS 80 (Rhein Chemie)
Vulcanization retardant: N-(Cyclohexylthio)phthalimide—PVI (Akrochem)

Different test sessions were carried out on a private racetrack, carrying out a series of maneuvers to test adherence and maneuverability both in dry and in wet conditions. The driver's evaluation is an average of the evaluations attributed in the various maneuvers.

In the test on a dry ground, the conditions were as follows.
Tyre inflation pressure: 2.3 bar; temperature of the track asphalt: 45° C.; air temperature: 30° C.

In the test on a wet ground, the conditions were as follows.
Tyre inflation pressure: 2.5 bar; temperature of the track asphalt: 29° C.; air temperature: 30° C.

The test was carried out with a motorcycle of the “Supersport” segment model BMW S1000RR.

The following Tables 6 and 7 summarize the scores attributed by the tester in the tests on a dry ground and, respectively, on a wet ground, for the various types of performance required to the tested tyre.

In Tables 6 and 7 the performance of the comparative tyre have been identified with the symbol “/”, whereas for the performance of the tyre according to the invention the symbol “=” has been used to indicate an evaluation of equal performance with respect to the comparative tyre and an improved performance with respect to the comparative tyre has been indicated by the symbol “+” with a greater number of said symbol denoting a greater improvement in performance.

TABLE 6
(tests on dry ground)

| | | |
|---|---|---|
| | Comparative | Front tyre according |
| Tyres | front tyre | to the invention |

Stability of travel

| | | |
|---|---|---|
| Stability of travel along a | / | = |
| straight course | | |
| Stability of travel when | / | = |
| driving along a bend | | |

Driving fundamentals

| | | |
|---|---|---|
| Readiness | / | ++ |
| Ease of driving | / | ++ |
| Drive/Thrust | / | + |
| Driving precision | / | ++ |

TABLE 7
(tests on wet ground)

| | Comparative | Front tyre according |
|---|---|---|
| Tyres | front tyre | to the invention |
| Front grip | / | ++ |
| Traction when braking | / | ++ |
| Feeling of safety | / | ++ |
| Driving precision | / | ++ |
| Drive/Thrust | / | ++ |

During the tests carried out it was also found that with the tyres according to the invention there were significant reductions in the lap times on the test circuits.

The results given in Tables 6 and 7 demonstrate that the tyre according to the invention has shown a much improved behavior with respect to the already excellent comparative tyre on a wet ground both in terms of adherence, and maneuverability, also for camber angles typically not reached on wet road surfaces for a front tyre.

The results given in Tables 6 and 7 also demonstrate that the tyre according to the invention has displayed analogous or even improved behavior with regard to performance on a dry ground.

Various modifications can be made to the embodiments described in detail, still remaining within the scope of protection of the invention, defined by the following claims.

1-27. (canceled)

28. A front motorcycle tyre comprising an equatorial plane (X-X) and a tread band having an overall axial extension (L),
wherein the tread band comprises:
a) a radially outer portion comprising:
a1) a central annular portion (L1) arranged astride the equatorial plane (X-X) of the tyre and made with a first vulcanized elastomeric material, and
a2) a pair of lateral annular portions (L2, L3) arranged at opposite sides of the central annular portion (L1) with respect to the equatorial plane (X-X) of the tyre, wherein the lateral annular portions (L2, L3) are made with a second vulcanized elastomeric material;
b) a radially inner portion extending below the radially outer portion of the tread band and along the entire axial extension thereof, wherein the radially inner portion is made with the first vulcanized elastomeric material;
wherein a ratio R1 between the dynamic elastic modulus E′ of the second vulcanized elastomeric material of the lateral annular portions (L2, L3) of the radially outer portion of the tread band, measured at a frequency of 10 Hz and at 23° C., and the dynamic elastic modulus E′ of the first vulcanized elastomeric material of the central annular portion (L1) of the radially outer portion and of the radially inner portion of the tread band, measured at a frequency of 10 Hz and at 23° C., ranges from 0.6 to 1.2; and
wherein a ratio R2 between the tandelta of the second vulcanized elastomeric material of the lateral annular portions (L2, L3) of the radially outer portion of the tread band, measured at a frequency of 10 Hz and at 70° C., and the tandelta of the first vulcanized elastomeric material of the central annular portion (L1) of the radially outer portion and of the radially inner portion of the tread band, measured at a frequency of 10 Hz and at 23° C., ranges from 0.6 to 1.2.

29. The front motorcycle tyre according to claim 28, wherein the first vulcanized elastomeric material of the central annular portion (L1) of the radially outer portion and of the radially inner portion of the tread band has a dynamic elastic modulus E′, measured at a frequency of 10 Hz and at 23° C., ranging from 5.7 MPa to 7.1 MPa.

30. The front motorcycle tyre according to claim 28, wherein the first vulcanized elastomeric material of the central annular portion (L1) of the radially outer portion and of the radially inner portion of the tread band has a tandelta, measured at a frequency of 10 Hz and at 23° C., ranging from 0.37 to 0.47.

31. The front motorcycle tyre according to claim 28, wherein the second vulcanized elastomeric material of the lateral annular portions (L2, L3) of the radially outer portion of the tread band has a dynamic elastic modulus E′, measured at a frequency of 10 Hz and at 23° C., ranging from 5.2 MPa to 6.5 MPa.

32. The front motorcycle tyre according to claim 28, wherein the second vulcanized elastomeric material of the lateral annular portions (L2, L3) of the radially outer portion of the tread band has a tandelta, measured at a frequency of 10 Hz and at 70° C., ranging from 0.34 to 0.44.

33. The front motorcycle tyre according to claim 28, wherein the first vulcanized elastomeric material of the central annular portion (L1) of the radially outer portion and of the radially inner portion of the tread band comprises, before vulcanization, 100 phr of at least one elastomeric diene polymer and from 70 phr to 110 phr of a white reinforcing filler comprising an amount equal to or greater than 80%, by weight of the total weight of the reinforcing fillers, of an inorganic material chosen from silica, alumina, silicates, hydrotalcite, calcium carbonate, kaolin, titanium dioxide and mixtures thereof.

34. The front motorcycle tyre according to claim 28, wherein the second vulcanized elastomeric material of the lateral annular portions (L2, L3) of the radially outer portion of the tread band comprises, before vulcanizing, an elastomeric material comprising 100 phr of at least one elastomeric diene polymer and from 40 phr to 100 phr, of a carbon black reinforcing filler.

35. The front motorcycle tyre according to claim 28, wherein the central annular portion (L1) of the radially outer portion of the tread band transversally extends along 5%-25%, of an axial half-extension (L/2) of the tread band.

36. The front motorcycle tyre according to claim 28, wherein an end proximal to the equatorial plane (X-X) of the lateral annular portions (L2, L3) of the radially outer portion of the tread band is arranged at a distance from the equatorial plane (X-X) of at least 10% of an axial half-extension (L/2) of the tread band.

37. The front motorcycle tyre according to claim 28, wherein each of the lateral annular portions (L2, L3) of the radially outer portion of the tread band is arranged axially outside and adjacent to the central annular portion (L1) to define an interface that separates along the axial direction the central annular portion (L1) and the lateral annular portions (L2, L3).

38. The front motorcycle tyre according to claim 28, wherein the lateral annular portions (L2, L3) of the radially outer portion of the tread band transversally extend along 75%-95%, of an axial half-extension (L/2) of the tread band.

39. The front motorcycle tyre according to claim 28, wherein the central annular portion (L1) of the radially outer portion of the tread band is substantially free of grooves.

40. The front motorcycle tyre according to claim 28, wherein the lateral annular portions (L2, L3) of the radially outer portion of the tread band each comprise a first lateral annular sub-portion (L2′, L3′), proximal to the equatorial plane (X-X), and a second lateral annular sub-portion (L2″, L3″), distal with respect to the equatorial plane (X-X),
and wherein the tyre comprises a plurality of grooves formed in the first lateral annular sub-portion (L2′, L3′) of the lateral annular portions (L2, L3) of the radially outer portion of the tread band.

41. The front motorcycle tyre according to claim 40, wherein the first lateral annular sub-portion (L2′, L3′) of the lateral annular portions (L2, L3) of the radially outer portion of the tread band transversally extends along 40%-65%, of an axial half-extension (L/2) of the tread band.

42. The front motorcycle tyre according to claim 40, wherein the plurality of grooves defines in the tread band an overall void to rubber ratio greater than or equal to 4% and less than or equal to 8%.

43. The front motorcycle tyre according to claim 40, wherein the plurality of grooves defines, in each first lateral annular sub-portion (L2′, L3′) of the lateral annular portions (L2, L3) of the radially outer portion of the tread band, a void to rubber ratio greater than or equal to 0% and less than or equal to 30%.

44. The front motorcycle tyre according to claim 43, wherein the plurality of grooves defines, in a first annular sector (A), arranged axially outside and adjacent to the central annular portion (L1), of each first lateral annular sub-portion (L2′, L3′) of the lateral annular portions (L2, L3) of the radially outer portion of the tread band, a void to rubber ratio increasing along an axial half-extension (L/2) of the tread band from the interface and moving away from the equatorial plane (X-X) of the tyre.

45. The front motorcycle tyre according to claim 44, wherein the first annular sector (A) transversally extends, from an end proximal to the equatorial plane (X-X) of the lateral annular portions (L2, L3) of the radially outer portion of the tread band, along 5%-25%, of the axial half-extension (L/2) of the tread band.

46. The front motorcycle tyre according to claim 44, wherein in the first annular sector (A) the void to rubber ratio increases from a minimum value of about 0% at the end proximal to the equatorial plane (X-X) of the lateral annular portions (L2, L3) of the radially outer portion of the tread band to a maximum value comprised between 20% and 30% at an axially outer end (A′) of the first annular sector (A).

47. The front motorcycle tyre according to claim 46, wherein the axially outer end (A′) of the first annular sector (A) is arranged at a distance from the equatorial plane (X-X) of the tyre of at least 13%, of the axial half-extension (L/2) of the tread band.

48. The front motorcycle tyre according to claim 44, wherein the plurality of grooves defines, in a second annular sector (B), arranged axially outside and adjacent to the first annular sector (A), of each first lateral annular sub-portion (L2′, L3′) of the lateral annular portions (L2, L3) of the radially outer portion of the tread band, a void to rubber ratio decreasing along the axial extension of the tread band from the first annular sector (A) and moving away from the equatorial plane (X-X) of the tyre.

49. The front motorcycle tyre according to claim 48, wherein the second annular sector (B) transversally extends from the first annular sector (A) along 15%-60%, of the axial half-extension (L/2) of the tread band.

50. The front motorcycle tyre according to claim 48, wherein in the second annular sector (B), the void to rubber ratio decreases from a maximum value of about 25% at the axially outer end (A′) of the first annular sector (A) to a minimum value equal to about 0% at an axially outer end of the first lateral annular sub-portion (L2′, L3′) of the lateral annular portions (L2, L3) of the radially outer portion of the tread band.

51. The front motorcycle tyre according to claim 40, wherein the axially outer end of the first lateral annular sub-portion (L2′, L3′) of the lateral annular portions (L2, L3) of the radially outer portion of the tread band is arranged at a distance from the equatorial plane (X-X) of the tyre of at least 55%, of the axial half-extension (L/2) of the tread band.

52. The front motorcycle tyre according to claim 40, wherein the second lateral annular sub-portion (L2″, L3″) of the lateral annular portions (L2, L3) of the radially outer portion of the tread band transversally extends along 10%-55%, of an axial half-extension (L/2) of the tread band.

53. The front motorcycle tyre according to claim 40, wherein each second lateral annular sub-portion (L2″, L3″) of the lateral annular portions (L2, L3) of the radially outer portion of the tread band is substantially free of grooves.

54. The front motorcycle tyre according to claim 28, wherein the tyre has a transversal curvature ratio equal to or greater than 0.35 and equal to or less than 0.50.
